(19) United States
(12) Patent Application Publication
(10) Pub. No.: US 2012/0252341 A1
(43) Pub. Date: Oct. 4, 2012

(54) HVAC CONTROL FOR MULTI-BLOWER UNIT

(75) Inventors: Hiromitsu Maehata, Nagoya City (JP); David Korenchuk, Royal Oak, MI (US); Delomer Gosioco, Royal Oak, MI (US); William Morris, Farmington Hills, MI (US)

(73) Assignee: DENSO International America, Inc., Southfield, MI (US)

(21) Appl. No.: 13/204,877

(22) Filed: Aug. 8, 2011

Related U.S. Application Data
(60) Provisional application No. 61/469,005, filed on Mar. 29, 2011.

(51) Int. Cl. B60H 1/24

(52) U.S. Cl. 454/75

(57) ABSTRACT

A climate control system includes ducts and a blocking member that regulates airflow through the ducts. An evaporator is disposed within the ducting assembly. The system also includes first and second blowers that blow air across the evaporator into the ducts. Additionally, the system includes a controller that determines a first target airflow to be delivered to a first cabin area, a second target airflow to be delivered to a second cabin area, a total target airflow, and a position for the blocking member. A first percentage of the total target airflow to be delivered by the first blower is defined according to the first target airflow, the second target airflow, and the total target airflow. Moreover, the controller controls the first blower to provide the first percentage of the total target airflow and controls the blocking member to move to the determined one of the plurality of positions.

### CROSS-REFERENCE TO RELATED APPLICATIONS

This application claims the benefit of U.S. Provisional Application No. 61/469,005, filed on Mar. 29, 2011, the disclosure of which is incorporated herein by reference in its entirety.

### FIELD

The present disclosure relates to an HVAC unit and, more particularly, to an HVAC control system for a multi-blower unit.

### BACKGROUND

This section provides background information related to the present disclosure which is not necessarily prior art.

Vehicles have been equipped with air conditioning systems (HVAC systems, climate control systems, etc.) for many years. Typically, these systems include a cooling cycle with an evaporator, condenser, compressor, etc., and refrigerant flows through the cooling cycle and changes temperature through the cycle. Air can flow over an evaporator of the cooling cycle to be chilled, and this chilled air can be delivered to the passenger cabin to thereby cool the passenger cabin.

Also, these HVAC systems can include a heater core that is heated by the vehicle engine. Air can flow over the heater core to be heated, and this heated air can be delivered to the passenger cabin to thereby heat the passenger cabin.

### SUMMARY

This section provides a general summary of the disclosure, and is not a comprehensive disclosure of its full scope or all of its features.

A climate control system for a vehicle having a first cabin area and a second cabin area is disclosed. The climate control system can include a ducting assembly with a first duct and a second duct. The first duct defines a first airflow path to the first cabin area, and the second duct defines a second airflow path to the second cabin area. The system also includes a blocking member that is moveably coupled to the ducting assembly. The blocking member is moveable between a plurality of positions to regulate airflow through at least one of the first and second ducts. An evaporator is disposed within the ducting assembly. The system also includes a first blower that blows air across the evaporator into at least one of the first duct and the second duct. The system further includes a second blower that blows air across the evaporator into at least one of the first duct and the second duct. Additionally, the system includes a controller that determines a first target airflow to be delivered to the first cabin area and a second target airflow to be delivered to the second cabin area. The controller also determines a total target airflow according to the determined first and second target airflows, and a first percentage of the total target airflow to be delivered by the first blower is defined according to the first target airflow, the second target airflow, and the total target airflow. The controller additionally determines which of the plurality of positions to place the blocking member to achieve substantially the total target airflow with the first blower providing the first percentage of the total target airflow. Moreover, the controller controls the first blower to provide the first percentage of the total target airflow and controls the blocking member to move to the determined one of the plurality of positions.

Also, a method of controlling a climate control system for a vehicle is disclosed. The vehicle includes a ducting assembly, an evaporator disposed in the ducting assembly, a first blower, a second blower, and a blocking member. The ducting assembly has a first duct that defines a first airflow path to a first cabin area, and the ducting assembly also has a second duct that defines a second airflow path to a second cabin area. The first and second blowers are each operable to blow air across the evaporator to at least one of the first and second ducts. The blocking member is moveable between a plurality of positions to regulate airflow through at least one of the first and second ducts. The method includes determining a first target airflow to be delivered to the first cabin area and a second target airflow to be delivered to the second cabin area. The method also includes determining a total target airflow according to the determined first and second target airflows. A first percentage of the total target airflow to be delivered by the first blower is defined according to the first target airflow, the second target airflow, and the total target airflow. The method further includes determining which of the plurality of positions to place the blocking member to achieve substantially the total target airflow with the first blower providing the first percentage of the total target airflow. Additionally, the method includes controlling the first blower to provide the first percentage of the total target airflow and controlling the blocking member to move to the determined one of the plurality of positions.

Still further, a method of controlling a climate control system for a vehicle is disclosed. The vehicle includes a ducting assembly, an evaporator disposed in the ducting assembly, a first blower, a second blower, and a blocking member. The ducting assembly has a first duct that defines a first airflow path to a first cabin area, and the ducting assembly also has a second duct that defines a second airflow path to a second cabin area. The first and second blowers are each operable to blow air across the evaporator to the first and second ducts. The blocking member is moveable between a plurality of positions to regulate airflow through the second duct. The plurality of positions include a closed position in which the blocking member substantially closes off the second duct, and the plurality of positions include a first open position and a second open position in which the blocking member allows different amounts of airflow through the second duct. The method includes determining a first target airflow to be delivered to the first cabin area and a second target airflow to be delivered to the second cabin area. The method also includes determining a total target airflow by adding the first and second target airflows. A first percentage of the total target airflow to be delivered by the first blower and a second percentage of the total target airflow to be delivered by the second blower are each defined according to the first target airflow, the second target airflow, and the total target airflow. Additionally, the method includes determining which of the plurality of positions to place the blocking member to achieve substantially the total target airflow with the first blower providing the first percentage of the total target airflow and the second blower providing the second percentage of the total target airflow. Furthermore, the method includes controlling the first blower to provide the first percentage of the total target airflow and controlling the blocking member to move to the determined one of the plurality of positions.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic sectional view of a vehicle with a climate control system configured according to the teachings of the present disclosure;

FIG. 2 is a schematic sectional view of the climate control system of the present disclosure;

FIG. 3 is a table representing exemplary data used for controlling the climate control system of FIG. 2;

FIG. 4 is a graph representing exemplary data used for controlling the climate control system of FIG. 2;

FIG. 5 is a table representing exemplary data used for controlling the climate control system of FIG. 2;

FIG. 6 is a table representing a plurality of control modes for controlling the climate control system of FIG. 2; and

FIG. 7 is a flowchart illustrating a method of operating the climate control system of FIG. 2.

Corresponding reference numerals indicate corresponding parts throughout the several views of the drawings.

### DETAILED DESCRIPTION

Example embodiments will now be described more fully with reference to the accompanying drawings.

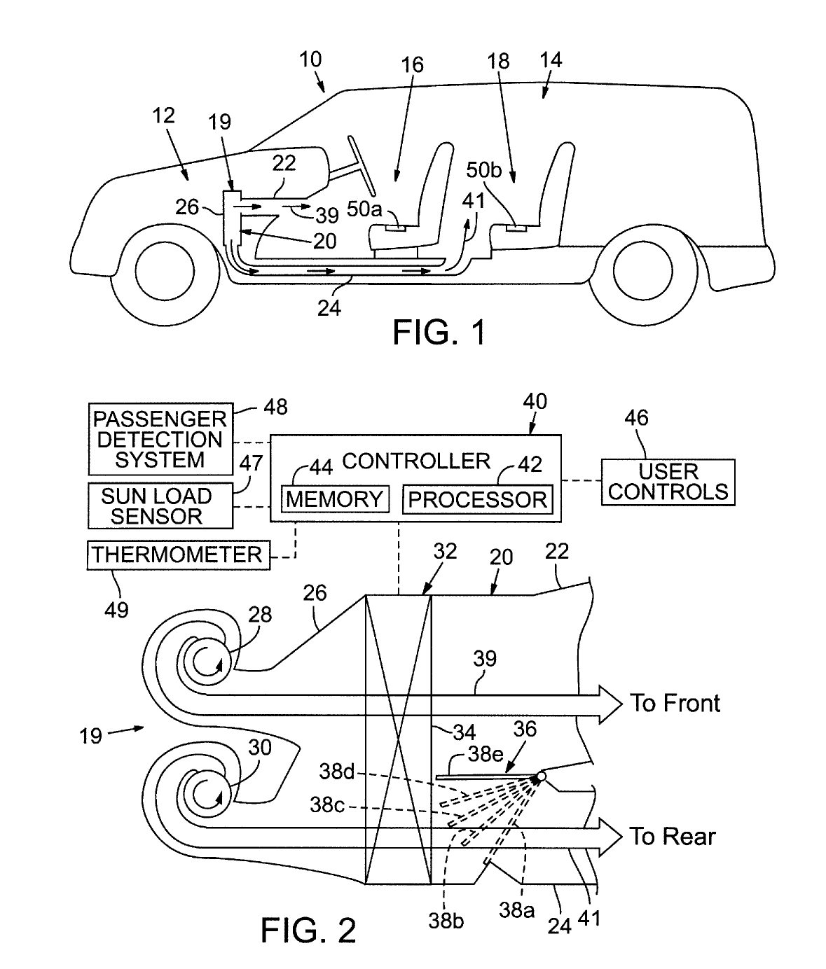

Referring initially to FIG. 1, a vehicle 10 is illustrated. The vehicle 10 can be of any suitable type. For instance, in the embodiment shown, the vehicle 10 is relatively large, such as a van, a minivan, or a sports-utility vehicle (SUV). The vehicle 10 can include an engine compartment 12 and a passenger cabin 14. The passenger cabin 14 can include a front cabin area 16 (i.e., a first cabin area) and a rear cabin area 18 (i.e., a second cabin area). The front and rear cabin areas 16, 18 can each include respective seating areas for passengers. Also, the rear cabin area 18 can include one or more cargo areas.

The vehicle 10 can include a climate control system 19 suitable for adjusting air temperature within the passenger cabin 14. The climate control system 19 can have various components, which will be discussed in detail below, for delivering chilled air into the passenger cabin 14. The climate control system 19 can also be used for delivering heated air into the passenger cabin 14 using one or more of the control methods disclosed herein. Also, the climate control system 19 can be used for delivering unchilled or unheated air from outside the vehicle 10 using one or more control methods disclosed herein. However, the control methods of the climate control system 19 will be discussed below as delivering cooled air into the passenger cabin 14.

The system 19 can include a ducting assembly 20 with a plurality of outlet ducts 22, 24 (shown in FIGS. 1 and 2). The ducting assembly 20 can include any number of outlet ducts 22, 24, and the outlet ducts 22, 24 can be positioned to deliver air to any suitable location (e.g., passenger's upper torso, footwells, windshield, etc.) within the passenger cabin 14. In the embodiments illustrated, for instance, the ducting assembly 20 can include a front outlet duct 22 (i.e., first duct) that delivers air primarily to the front cabin area 16 and a rear outlet duct 24 (i.e., second duct) that delivers air primarily to the rear cabin area 18. As will be discussed, air can be chilled within the system 19, and air can selectively flow to the passenger cabin 14 via the front and rear ducts 22, 24. Also, as will be discussed, the total airflow from both front and rear ducts 22, 24 can be variably and selectively controlled such that the climate control system 19 can effectively and efficiently cool the passenger cabin 14.

Referring now to FIG. 2, the embodiments of the climate control system 19 are illustrated in greater detail. As shown, the climate control system 19 can include a first blower 28 and a second blower 30. The blowers 28, 30 can be of any suitable type, such as commercially-available blowers. The blowers 28, 30 can each be driven by electrical motors (not specifically shown) such that the speed of the blowers 28, 30 can be independently controlled according to the voltage provided to each blower 28, 30. Thus, by selectively controlling the speed of the blowers 28, 30, the total airflow (blowing output) from each blower 28, 30 can be independently controlled.

Moreover, the system 19 can include a cooling cycle (i.e., refrigeration cycle), which is generally indicated at 32. Of the cooling cycle 32, only an evaporator 34 is shown in FIG. 2; however, it will be appreciated that the cooling cycle 32 can also include a condenser, a compressor, an expansion valve, etc. that are fluidly connected to the evaporator 34, as is known. The evaporator 34 can be disposed within a common plenum 26 of the ducting assembly 20, upstream of the front and rear outlet ducts 22, 24.

Commercially available refrigerant can continuously flow through the cooling cycle 32, and the temperature and pressure of the refrigerant can change as it does so. Specifically, low temperature and low pressure refrigerant can flow (e.g., from an expansion valve) through the evaporator 34, and warmer air from the blowers 28, 30 can flow across the evaporator 34 to be chilled before being introduced into the passenger cabin 14.

In some embodiments, the vehicle 10 can include only one climate control system 19, and that system 19 can include only one cooling cycle 32 having a single evaporator 34 (as well as a single condenser, compressor, expansion valve, etc.). This can reduce manufacturing costs of the vehicle 10. Regardless of the fact that the system 19 includes only a single cooling cycle 32, the system 19 can have sufficient cooling capacity for cooling vans, minivans, SUVs, and other large vehicles.

The climate control system 19 can additionally include at least one blocking member 36. The blocking member 36 can be a flat plate or door that is moveably coupled (e.g., pivotally coupled) to the ducting assembly 20, adjacent the upstream end of the rear outlet duct 24. The blocking member 36 can have a plurality of positions. For instance, in the embodiments illustrated, the blocking member 36 can have a first position 38a, a second position 38b, a third position 38c, a fourth position 38d, and a fifth position 38e. In the first position 38a (i.e., a closed position), the blocking member 36 can substantially close off the upstream end of the rear outlet duct 24. In each of the second through fifth positions 38b-38e (i.e., open positions), the blocking member 36 can be progressively pivoted away from the rear outlet duct 24 and can allow progressively more airflow through the rear outlet duct 24.

Each of the blowers 28, 30 can blow air along a respective airflow path, each of which is illustrated by an arrow at 39 and 41. The first blower 28 can blow air along a first airflow path 39, primarily through the front outlet duct 22 to the front cabin area 16, because the first blower 28 is substantially aligned with the front outlet duct 22. Also, the second blower 30 can blow air along a second airflow path 41, primarily through the rear outlet duct 24 to the rear cabin area 18, because the second blower 30 is substantially aligned with the rear outlet duct 22 and because the blocking member 36 is in the fifth position 38e. In other words, because the rear outlet duct 22 is fully open when the blocking member 36 is in the fifth position 38e, air from the second blower 30 can flow primarily through the rear outlet duct 22. When the blocking member 36 is in the fourth position 38d, the rear outlet duct 22 is partially closed, and as a result, the blocking member 36 can direct some of the air from the second blower 30 into the front outlet duct 22 (i.e., the second airflow path 41 would branch partially into the front outlet duct 22 and partially into the rear outlet duct 24). It will be appreciated, then, that the blocking member 36 can regulate airflow through the front and rear outlet ducts 22, 24.

It will be appreciated that the blocking member 36 can have any suitable number of positions 38a-38e and the blocking member 36 can be disposed at any predetermined angle or position relative to the rear outlet duct 24. Moreover, in some embodiments, the system 19 can include a plurality of blocking members 36. Also, the blocking member 36 can be moveably coupled on the front outlet duct 22 to substantially close off and alternatively allow airflow through the front outlet duct 22.

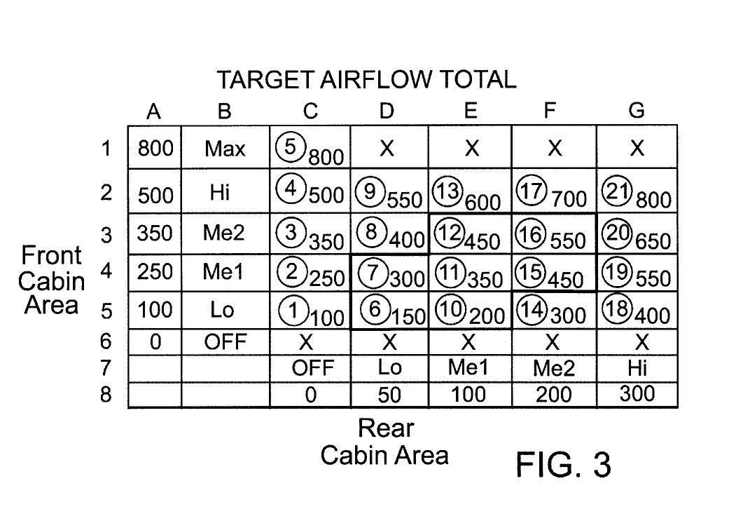

The climate control system 19 can further include a controller 40. The controller 40 can include various hardware, software, and other components similar to a computer. Specifically, the controller 40 can include a processor 42 and a memory device 44 (e.g., RAM and/or ROM). The processor 42 and memory device 44 can be conventional types. Also, the memory device 44 can include look-up tables, graphs, and other stored data as represented in FIGS. 3-6. The controller 40 can be used to control the speed of each of the blowers 28, 30 (e.g., by varying the voltage supplied to each) and can also control the position of the blocking member 36. The controller 40 can control the blowers 28, 30 and the position of the blocking member 36 according to programmed logic and look-up tables, graphs, etc. represented, for example, in FIGS. 3-6. The controller 40 can also control the temperature of the air flowing to the passenger cabin 14 by controlling the cooling cycle 32.

Moreover, the climate control system 19 can include user controls 46. The user controls 46 can include buttons, sliders, dials, or any other device with which a passenger can input control commands to the controller 40. For instance, the user can manually set a desired temperature for the passenger cabin 14 (e.g., a desired temperature for the front cabin area 16 and a different desired temperature for the rear cabin area 18). The user can also manually indicate whether to deliver air to the front or rear cabin areas 16, 18 or further specify where to direct the airflow within the passenger cabin 14 (e.g., toward the windshield, toward the floor, etc.).

Furthermore, the climate control system 19 can include a sun load sensor 47. The sun load sensor 47 can be a light-sensitive sensor of a known type, which is operable to detect an amount and intensity of sunlight falling on the vehicle 10. The sun load sensor 47 can also be operable to detect a sunlight intensity for the front cabin area 16 and a different sunlight intensity for the rear cabin area 18.

The climate control system 19 can additionally include one or more thermometers 49. The thermometer(s) 49 can be of any suitable type for detecting temperature inside the passenger cabin 14 and/or detecting ambient temperature outside the vehicle 10. In some embodiments the thermometer(s) 49 can detect a temperature within the front cabin area 16 and a different temperature within the rear cabin area 18.

Still further, the system 19 can include a passenger detection system 48 that is operable to detect the presence, absence, and location of passengers within the passenger cabin 14 (e.g., detects occupancy within the front and rear cabin areas 16, 18). The passenger detection system 48 can be an electronic system employing Hall effect sensors 50a, 50b that are mounted within the seats of the passenger cabin 14 (see FIG. 1). The passenger detecting system 48 can also detect passengers visually (e.g., with one or more cameras), thermally (e.g., with heat-sensitive instruments), or using any other suitable devices.

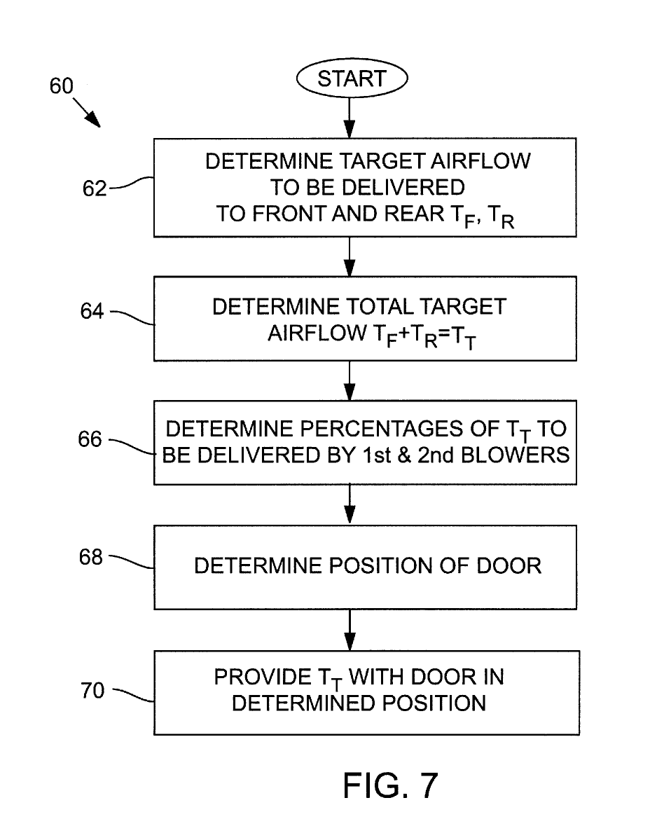

Thus, during operation, the controller 40 can control airflow output of the first and second blowers 28, 30 (e.g., by controlling voltage supplied to each) and can also control movement of the blocking member 36 between its positions 38a-38e to thereby regulate airflow to the front and rear cabin areas 16, 18. The voltage supplied to each blower 28, 30 and the position of the blocking member 36 can be controlled according to a method 60 represented in FIG. 7.

The method 60 can begin in block 62, wherein the controller 40 determines how much airflow (airflow volume) should be delivered to the front cabin area 16 and how much airflow should be delivered to the rear cabin area 18. The target airflow to be delivered to the front cabin area 16 (i.e., first target airflow) is denoted as T_{F} in FIG. 7, and the target airflow to be delivered to the rear cabin area 18 (i.e., second target airflow volume) is denoted as T_{R} in FIG. 7.

Then, in block 64, the controller 40 determines a total target airflow T_{T} according to the first and second target airflow T_{F}, T_{R}. In the embodiments illustrated, the processor 42 adds the first and second target airflows to determine the total target airflow T_{T}; however, the total target airflow T_{T} could be determined according to any other suitable algorithm, taking the first and second target airflows T_{F}, T_{R} into account.

Next, in block 66, the controller 40 determines the percentage of the total target airflow volume T_{T} that will be delivered by the first blower 28 (i.e., the first percentage). Also, the controller 40 also determines the percentage of the total target airflow volume T_{T} that will be delivered by the second blower 30. Subsequently, in block 68, the controller 40 can determine which of the positions 38a-38e to move the blocking member 36. Then, in block 70, the controller 40 can operate the blower(s) 28, 30 according to the determinations made in block 66 and can position the blocking member 36 according to the determination made in block 68.

As will be discussed, the climate control system 19 can be operated such that the first blower 28 provides 100% of the total airflow volume T_{T} in many cases. That is, the second blower 30 can remain OFF unless the first blower 28 is unable to provide some of the total airflow volume T_{T}. The blocking member 36 can also be moved between its various positions 38a-38e such that the necessary amount of airflow is provided to each of the front and rear cabin areas 16, 18. Accordingly, as will be discussed, the system 19 can be operated very efficiently.

In some embodiments, the target airflows T_{F}, T_{R} can be determined by the controller 40 (block 62) by gathering data from the thermometer(s) 49, the sun load sensor 47, the passenger detection system 48, and/or the user controls 46. Specifically, the airflow targets T_{F}, T_{R} can be determined according to temperature(s) detected by the thermometer 49, the sun load detected by the sun load sensor 47, the number and location of the occupants detected by the passenger detection system 48, the target temperature setting on the user controls 46, etc. Once these targets T_{F}, T_{R} are determined, the processor 42 can calculate the total target airflow T_{T} (block 64).

For example, in FIG. 3, different target airflows T_{F} to be delivered to the front cabin area 16 are listed in column A. These different targets T_{F} (800 m³/h, 500 m³/h, 350 m³/h, 250 m³/h, 100 m³/h, and 0 m³/h) correspond to the blower settings listed in column B (Maximum, Hi, Medium 2, Medium 1, Low, and OFF, respectively). Also, different target airflows T_{R} to be delivered to the rear cabin area 18 are listed in row 8. By adding the target airflows T_{F} and T_{R}, the processor 42 can determine the total target airflows both cabin areas 16, 18. (The different total target airflows T_{T} are included at each intersection of row and column). In the embodiments shown, there are twenty-one different total target airflows T_{T}.

Assuming that the controller 40 has determined the target airflow T_{F} to be delivered to the front cabin area 16 is 350 m³/h and the target airflow T_{R} to be delivered to the rear cabin area 18 is 200 m³/h, the processor 42 will calculate the total target airflow T_{T} to be 550 m³/h. Thus, according to the look-up table of FIG. 3, the system 19 will be in mode “16” (at cell F3).

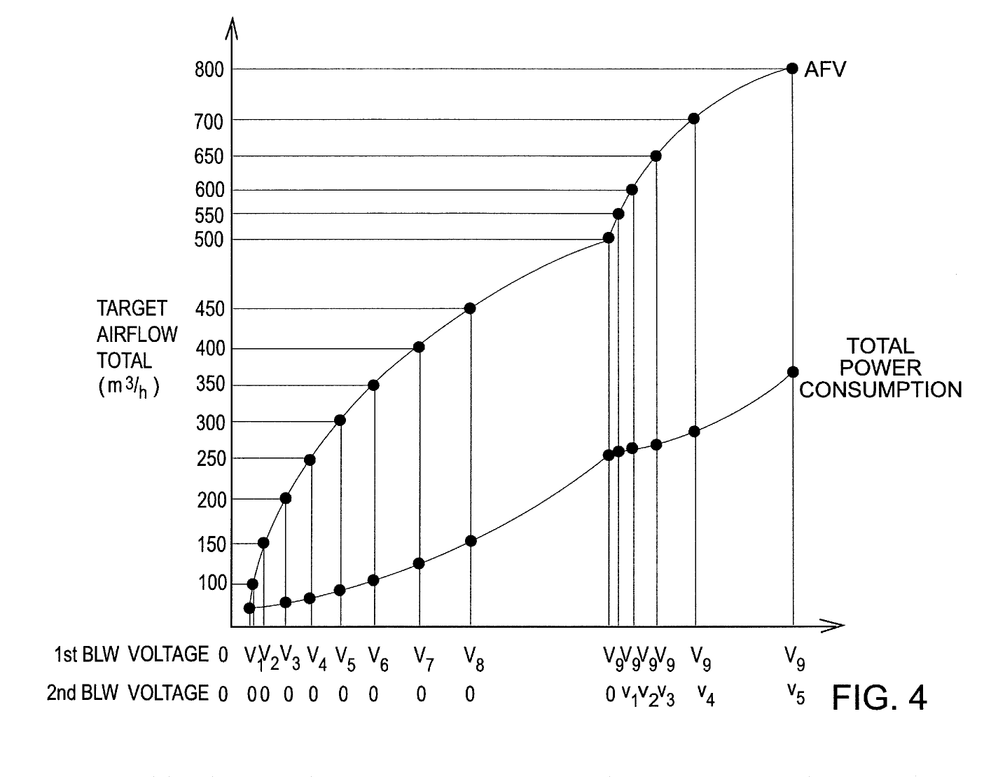

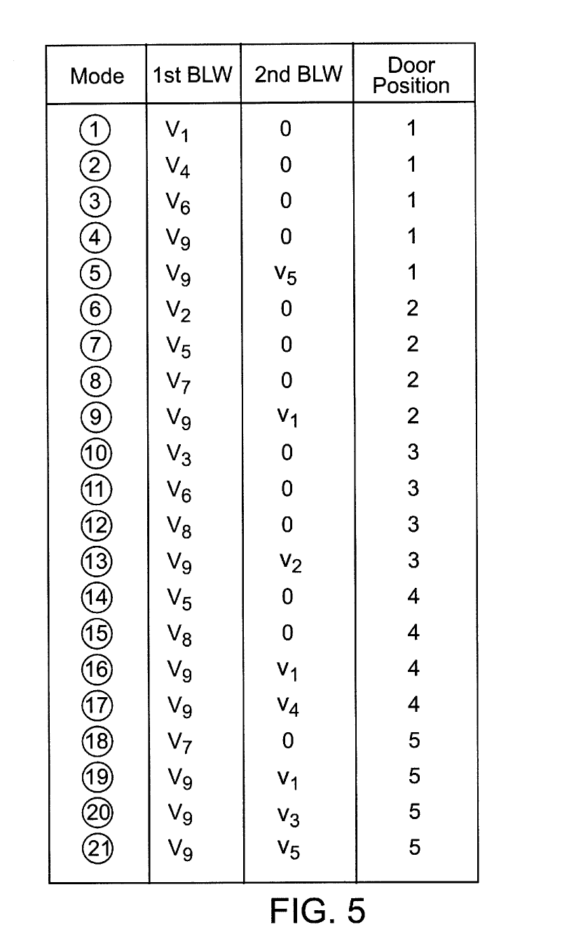

Then, the controller 40 can refer to the look-up table of FIG. 5 to determine where to position the blocking member 36 to deliver this 550 m³/h of air. As shown in FIG. 5, for mode “16,” the blocking member 36 should be moved to its fourth position 38d. The data of FIGS. 4 and 5 can also indicate the voltages to be delivered to the first and second blowers 28, 30. For instance, for mode “16,” the voltage for the first blower 28 should be V9 (i.e., the highest possible voltage) and the voltage for the second blower 30 should be v1 (i.e., the lowest possible voltage). Accordingly, the system 19 can deliver the 550 m³/h of air, and with the blocking member 36 in the fourth position 38d, the air can be distributed as intended to the front and rear cabin areas 16, 18.

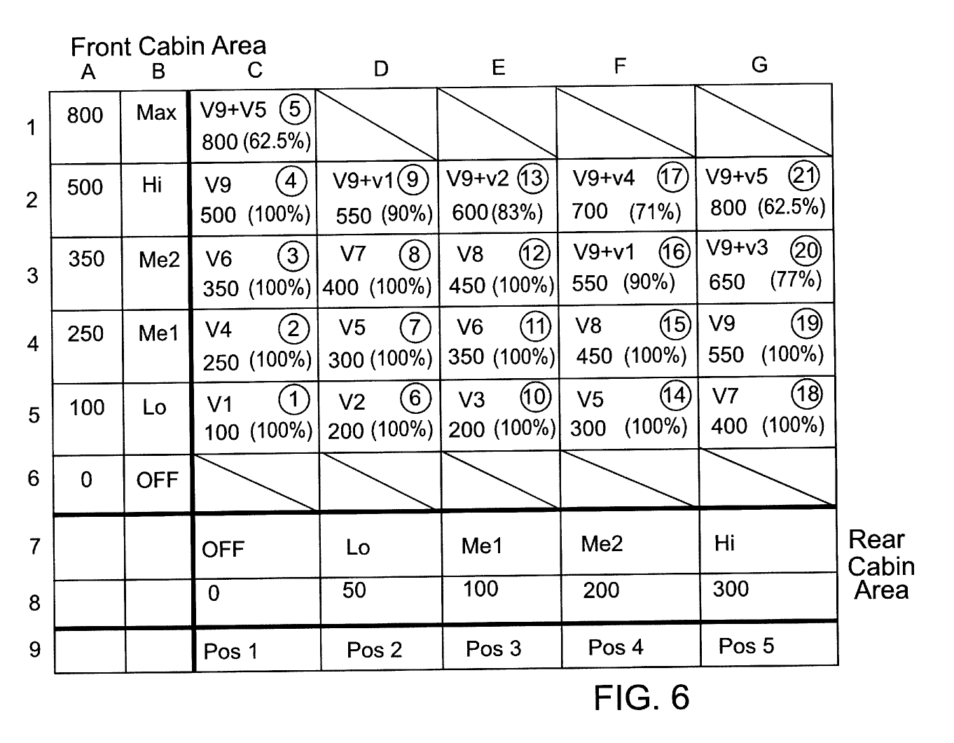

The data of FIGS. 3-5 can be compiled as represented in FIG. 6. Similar to FIG. 3, the different target airflows T_{F} to be delivered to the front cabin area 16 are included in column A, and the different target airflows T_{R} to be delivered to the rear cabin area 18 are included in row 8. Thus, the different total target airflows T_{T} are shown at the intersections of rows and columns. The positions of the blocking member 36 are included in row 9.

Also shown in parentheses in FIG. 6 is the percentage of the total target airflow T_{T} that the first blower 28 provides in each mode. These percentages can be predetermined and included in the look-up table(s) stored in the memory device 44. These percentages are based on a ratio of the voltages provided to each of the blowers 28, 30. Also, instead of percentages, these values can be expressed as ratios of the outputs of the first and second blowers 28, 30.

For instance, where the target airflow T_{F} to be delivered to the front cabin area 16 is 350 m³/h and the target airflow T_{R} to be delivered to the rear cabin area 18 is 200 m³/h, cell F3 shows that the first blower 28 will provide 90% of the total target airflow T_{T} (550 m³/h). It follows, then, that the second blower 30 will provide 10% of the total target airflow T_{T}. In these modes, the blocking member 36 will be moved to the fourth position 38d such that the 350 m³/h is delivered to the front cabin area 16 and the 200 m³/h is delivered to the rear cabin area 18.

As shown in FIG. 6, the system 19 can be operated and controlled in a variety of modes in which the first blower 28 provides 100% of the total target airflow T_{T} (and the second blower 30 provides 0% of the total target airflow T_{T}). Specifically, in modes 1-4, 6-8, 10-12, 14, 15, 18, and 19, the first blower 28 provides 100% of the total target airflow T_{T}. Also, in the other modes (modes 5, 9, 13, 16, 17, 20, and 21), the voltage V9 supplied to the first blower 28 is maximized (i.e., operates at full speed) while the second blower 30 merely provides supplemental airflow.

Accordingly, the system 19 can cool the passenger cabin 14 in a very efficient manner, despite including only a single evaporator 34, even if the vehicle 10 has a relatively large passenger cabin 14. Also, power consumption can be relatively low, and the vehicle 10 can have improved fuel economy as a result.

As shown in FIGS. 3-6, there are many modes (twenty-one) that are represented; however, there can be any number of modes, and each mode can include any combination of blower voltages and position for the blocking member 36. It will be appreciated that in FIGS. 4 and 5, V1 represents the lowest voltage provided to the first blower 28 and V9 represents the highest voltage provided to the first blower 28. Also, it will be appreciated that v1 represents the lowest voltage provided to the second blower 30 and v5 represents the highest voltage provided to the second blower 30. Moreover, it will be appreciated that although look-up tables are provided in the embodiments discussed above, the controller 40 can rely on any algorithm, data, or other tool for controlling the system 19 without departing from the scope of the present disclosure. Additionally, if the target airflows do not exactly match any of the modes stored in the look-up tables, the controller 40 can find the stored mode that most closely matches the actual target airflows.

In some modes shown in FIG. 5, (e.g., modes “1” through “4”, modes “6” through “8”, modes “14” through “15”, and mode “18”), voltage is supplied to the first blower 28 only while the second blower 30 remains OFF (i.e., zero voltage supplied to the second blower 30). Accordingly, less power can be consumed because only the first blower 28 is needed for cooling the passenger cabin 14.

Also, in some modes (e.g., modes “1” through “5”), the blocking member 36 remains in the first position to substantially close off the rear outlet duct 24. As such, air can be delivered directly to the front cabin area 16.

Furthermore, there can be a “priority” mode (i.e., “priority” mode). In the embodiments shown, the “priority” mode is represented in mode “5”, wherein maximum voltage is supplied to the first and second blowers 28, 30 (V₉ and v₅, respectively) while the blocking member 36 substantially closes off the rear outlet duct 24. As such, a maximum amount of air volume can be delivered to the front cabin area 16. The controller 40 can automatically switch to the “priority” mode, for instance, if the passenger detecting system 48 detects passengers within the front cabin area 16 only, if the thermometer 49 detects high ambient temperature and/or high temperature inside the passenger cabin 14, and/or if high sun load is detected by the sensor 47. Also, the user controls 46 can have a control (e.g., a button, etc.) for manually setting the system 19 in this priority mode.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A climate control system for a vehicle having a first cabin area and a second cabin area, the climate control system comprising:
a ducting assembly with a first duct and a second duct, the first duct defining a first airflow path to the first cabin area, the second duct defining a second airflow path to the second cabin area;
a blocking member that is moveably coupled to the ducting assembly, the blocking member moveable between a plurality of positions to regulate airflow through at least one of the first and second ducts;
an evaporator disposed within the ducting assembly;
a first blower that blows air across the evaporator into at least one of the first duct and the second duct;
a second blower that blows air across the evaporator into at least one of the first duct and the second duct; and
a controller that:
determines a first target airflow to be delivered to the first cabin area and a second target airflow to be delivered to the second cabin area,
determines a total target airflow according to the determined first and second target airflows, a first percentage of the total target airflow to be delivered by the first blower being defined according to the first target airflow, the second target airflow, and the total target airflow,
determines which of the plurality of positions to place the blocking member to achieve substantially the total target airflow with the first blower providing the first percentage of the total target airflow,
controls the first blower to provide the first percentage of the total target airflow, and
controls the blocking member to move to the determined one of the plurality of positions.

2. The climate control system of claim 1, wherein the controller has a plurality of different modes that cause the first blower to provide 100% of the total target airflow, and that cause the blocking member to be in a different position in each of the plurality of different modes.

3. The climate control system of claim 1, wherein the first cabin area is a front passenger cabin area and the second cabin area is a rear passenger cabin area.

4. The climate control system of claim 1, wherein the blocking member has a closed position in which the blocking member substantially closes off the second duct, and wherein the blocking member has an open position in which the blocking member allows airflow through the second duct.

5. The climate control system of claim 1, wherein the blocking member has a plurality of open positions, and wherein the blocking member allows different amounts of airflow through the second duct in the plurality of open positions.

6. The climate control system of claim 5, wherein the blocking member is pivotally coupled to the ducting assembly to pivot relative the second duct between a closed position and the plurality of open positions, the blocking member substantially closing off the second duct when in the closed position.

7. The climate control system of claim 1, wherein the controller has a priority mode in which the controller increases airflow output from both the first and second blowers to a highest respective level.

8. The climate control system of claim 7, further comprising a sensor that detects occupancy within the first and second cabin areas, and wherein the controller is in priority mode when the sensor detects a passenger in the first cabin area only.

9. The climate control system of claim 7, further comprising a user control with which a user sets the controller in the priority mode.

10. The climate control system of claim 7, wherein the blocking member has a closed position in which the blocking member substantially closes off the second duct, and wherein the controller moves the blocking member to the closed position when in the priority mode.

11. A method of controlling a climate control system for a vehicle with a ducting assembly, an evaporator disposed in the ducting assembly, a first blower, a second blower, and a blocking member, the ducting assembly having a first duct that defines a first airflow path to a first cabin area, the ducting assembly also having a second duct that defines a second airflow path to a second cabin area, the first and second blowers each operable to blow air across the evaporator to at least one of the first and second ducts, the blocking member moveable between a plurality of positions to regulate airflow through at least one of the first and second ducts, the method comprising:
determining a first target airflow to be delivered to the first cabin area and a second target airflow to be delivered to the second cabin area;
determining a total target airflow according to the determined first and second target airflows, a first percentage of the total target airflow to be delivered by the first blower being defined according to the first target airflow, the second target airflow, and the total target airflow;
determining which of the plurality of positions to place the blocking member to achieve substantially the total target airflow with the first blower providing the first percentage of the total target airflow; and
controlling the first blower to provide the first percentage of the total target airflow and controlling the blocking member to move to the determined one of the plurality of positions.

12. The method of claim 11, wherein the blocking member has a closed position and an open position, the blocking member substantially closing off the second duct in the closed position, the blocking member allowing airflow through the second duct in the open position, and wherein determining which of the plurality of positions to place the blocking member includes determining whether to place the blocking member in one of the closed position and the open position.

13. The method of claim 11, wherein the blocking member has a plurality of open positions, wherein the blocking member allows different amounts of airflow through the second duct in the plurality of open positions, and wherein determining which of the plurality of positions to place the blocking member includes determining which of the plurality of open positions to place the blocking member.

14. The method of claim 11, further comprising detecting occupancy within the first cabin area and the second cabin area, and increasing airflow output from both the first and second blowers to a highest level and moving the blocking member to a closed position in which the blocking member substantially closes off the second duct when an occupant is detected in the first cabin area only.

15. The method of claim 11, further comprising increasing airflow output from both the first and second blowers to a highest level and moving the blocking member to a closed position in which the blocking member substantially closes off the second duct when a user sets the climate control system to a priority mode.

16. The method of claim 11, further comprising choosing from a plurality of different modes in which the first blower provides 100% of total target airflow, and the second blower provides 0% of total target airflow, the blocking member being in a different position in each of the plurality of different modes.

17. A method of controlling a climate control system for a vehicle with a ducting assembly, an evaporator disposed in the ducting assembly, a first blower, a second blower, and a blocking member, the ducting assembly having a first duct that defines a first airflow path to a first cabin area, the ducting assembly also having a second duct that defines a second airflow path to a second cabin area, the first and second blowers each operable to blow air across the evaporator to the first and second ducts, the blocking member moveable between a plurality of positions to regulate airflow through the second duct, the plurality of positions including a closed position in which the blocking member substantially closes off the second duct, the plurality of positions also including a first open position and a second open position in which the blocking member allows different amounts of airflow through the second duct, the method comprising:
determining a first target airflow to be delivered to the first cabin area and a second target airflow to be delivered to the second cabin area;
determining a total target airflow by adding the first and second target airflows, a first percentage of the total target airflow to be delivered by the first blower and a second percentage of the total target airflow to be delivered by the second blower each being defined according to the first target airflow, the second target airflow, and the total target airflow;
determining which of the plurality of positions to place the blocking member to achieve substantially the total target airflow with the first blower providing the first percentage of the total target airflow and the second blower providing the second percentage of the total target airflow; and
controlling the first blower to provide the first percentage of the total target airflow, controlling the second blower to provide the second percentage of the total target airflow, and controlling the blocking member to move to the determined one of the plurality of positions.

18. The method of claim 17, further comprising choosing from a plurality of different modes in which the first blower provides 100% of total target airflow, and the second blower provides 0% of total target airflow, the blocking member being in a different position in each of the plurality of different modes.
